(19) United States
(12) Patent Application Publication
(10) Pub. No.: US 2008/0102337 A1
(43) Pub. Date: May 1, 2008

(54) Solid Oxide Type Fuel Battery Cell and Process for Producing the Same

(75) Inventor: Hiroyuki Shimada, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: THE TOKYO ELECTRIC POWER COMPANY, INCORPORATED, Tokyo (JP)

(21) Appl. No.: 11/662,924

(22) PCT Filed: Jan. 13, 2006
(86) PCT No.: PCT/JP06/00786

§ 371 Date: Nov. 15, 2007

(30) Foreign Application Priority Data
Feb. 28, 2005 (JP) 2005-052648

(51) Int. Cl. H01M 8/10; B05D 1/00

(52) U.S. Cl. 429/30; 427/115

(57) ABSTRACT

A process for producing a cell for solid oxide fuel cells comprising a porous electrolyte layer-forming step of obtaining an electrolyte substrate in which a porous electrolyte layer is formed by applying a slurry for forming an electrolyte layer containing an electrolyte substance powder and a pore-forming agent to the surface of an electrolyte substrate and burning the electrolyte substrate, and an electrode layer-forming step of obtaining an electrolyte substrate in which an electrode substance-filled porous electrolyte layer and an electrode layer are formed by applying a slurry for forming an electrode containing an electrode substance powder, a mixture of an electrode substance powder and an electrolyte substance powder, or a composite material powder of an electrode substance and an electrolyte substance, onto the surface of the porous electrolyte layer of the electrolyte substrate on which the porous electrolyte layer is formed, and burning the electrolyte substrate in which the porous electrolyte layer is formed. According to the present invention, a process for producing a cell for solid oxide fuel cells which can increase the three-phase interface of the porous electrolyte layer and exhibits only a small conductivity reduction of the electrolyte layer can be obtained.

### TECHNICAL FIELD

The present invention relates to a cell for solid oxide fuel cells and a process for producing the same.

### BACKGROUND ART

A cell of a solid oxide fuel cell has an electrolyte sandwiched by a fuel electrode and an air electrode. The electrolyte, fuel electrode, and air electrode are formed of a metal oxide or a metal. Thus, the cell is entirely a solid.

In the solid oxide fuel cell, a cell reaction occurs in a three-phase interface in which all of the gases, the ions, and the electrons are reactive. For this reason, the three-phase interface area must be increased in order to promote cell performance.

Conventionally, a method of increasing the three-phase interface area by mixing an electrolyte substance with an electrode substance, and further forming an electrode with a porous structure has been used. In this method, the three-phase interface is increased by increasing not only the contact area of the electrolyte substance with the electrode substance, but also by forming the three-phase interface in the electrode. Specifically, an electrode having a porous structure in which an electrolyte substance is mixed with an electrode substance was prepared from powdery composite particles containing mother particles and child particles, the latter being fixed to the former, by using either the mother particles or the child particles as an electrolyte substance and the other as a fuel electrode substance or an air electrode substance. In the present invention, a fuel electrode substance refers to a substance capable of producing water and electrons from a hydrogen fuel and oxide ions, and capable of conducting electrons, an air electrode substance refers to a substance capable of producing oxide ions from oxygen and electrons and conducting electrons, and an electrolyte substance refers to a substance capable of conducting oxide ions generated in an air electrode to a fuel electrode.

As such composite particles and an electrode formed from the composite particles, for example, JP-A-10-144337 (Patent Document 1) discloses composite particles comprising a metal having electrode activity (for example, nickel oxide) supported on the surface of an oxide having oxygen ion conductivity (for example, yttria-stabilized zirconia) and a fuel electrode for solid electrolyte fuel cells made from such composite particles.

However, there is naturally a limit to the amount of the three-phase interface increased by decreasing the particle size of the mother particles and the child particles.

Therefore, a method of increasing the amount of the three-phase interface by forming a three-phase interface also in an electrolyte layer by forming the electrolyte layer from a porous material and filing the pores with an electrode substance has been used. For example, JP-A-3-147264 discloses a solid electrolyte fuel cell comprising a porous layer of zirconia previously attached to the interface of a fuel electrode and a solid electrolyte board which is present between the fuel electrode and an oxidizer electrode, and forming the fuel electrode from nickel or a nickel-zirconia mixture filled in the porous layer and the pores.

### Patent Document 1: JP-A-10-144337 (Example 1)

### Patent Document 2: JP-A-3-147264 (claims and examples)

In the method of JP-A-3-147264, pores are formed by applying a slurry in which an electrolyte substance powder is dispersed in a solvent such as ethanol or a liquid component containing a binder such as polyvinyl butyral dissolved in the solvent to the surface of an electrolyte board and baking the coating. The pores are formed by burning down of the liquid component. However, the liquid component exists in the slurry filling out the clearance between spherical electrolyte substances. It was difficult to control the shape of the liquid component in the slurry due to its liquid properties, that is, it was difficult to control the shape of the pores after burning. For this reason, among the pores formed in the porous electrolyte layer, there are some pores with a size (diameter) which is not large enough to fill an electrode substance such as nickel therein. Therefore, in the method disclosed in JP-A-3-147264, in order to form many pores with a size (diameter) large enough to fill an electrode substance such as nickel therein, it was necessary to increase the ratio of the amount of the liquid component to the amount of the electrolyte substance powder in the slurry so that the possibility of producing pores with a diameter large enough to fill an electrode substance may be increased. However, a large proportion of the liquid component in the slurry increases the pore volume of the electrolyte layer and decreases the amount of the electrolyte substance powder in the electrolyte layer, resulting in a decrease of passages in which electrons move, which in turn decreases conductivity of the electrolyte layer. Lowered conductivity leads to a low output of the fuel cell. For this reason, it was difficult to increase the three-phase interface without reducing the conductivity by using the method of JP-A-3-147264.

Therefore, an object of the present invention is to provide a method for producing a cell for solid oxide fuel cells which can increase the three-phase interface of the porous electrolyte layer and exhibits only a small conductivity reduction of the electrolyte layer.

### DISCLOSURE OF THE INVENTION

As a result of extensive research in order to achieve the above object, the present inventors have found that (1) if a solid pore-forming agent is added to a slurry for forming a porous electrolyte layer, it is possible to control the shape of the pores in the porous electrolyte layer, specifically, since the pore-forming agent is present in the clearance between the particles of electrolyte substance powder in the slurry and therefore, the size of the clearance is not smaller than the particle size of the pore-forming agent, the clearance between the particles of electrolyte substance powder, that is, the pore diameter after burning, can be greater than the diameter of the pore-forming agent. For this reason, pores having a diameter sufficiently large for an electrode substance to be filled therein can be surely formed, which ensures only a small decrease in the conductivity of the porous electrolyte layer and an increase in the amount of the three-phase interface. The inventors have further found that (2) if the average particle diameter of the electrolyte substance powder is smaller than the average particle diameter of the said pore-forming agent, the contact area of the electrolyte substance powder can be increased and the particles of the electrolyte substance powder can be more easily sintered among themselves, which results in an increase in the conductivity of the porous electrolyte layer.

Specifically, an object of the present invention (1) is to provide a process for producing a cell for solid oxide fuel cells comprising a porous electrolyte layer-forming step for obtaining an electrolyte substrate in which a porous electrolyte layer is formed by applying a slurry for forming an electrolyte layer containing an electrolyte substance powder and a pore-forming agent to the surface of an electrolyte substrate and burning the electrolyte substrate, and an electrode layer-forming step for obtaining an electrolyte substrate in which a porous electrolyte layer filled with an electrode substance (electrode substance-filled porous electrolyte layer) and an electrode layer are formed by applying a slurry for forming an electrode containing an electrode substance powder, a mixture of an electrode substance powder and an electrolyte substance powder, or a composite material powder of an electrode substance and an electrolyte substance, onto the surface of the porous electrolyte layer of the electrolyte substrate on which the porous electrolyte layer is formed, and burning the electrolyte substrate in which the porous electrolyte layer is formed.

The present invention (2) provides a cell for solid oxide fuel cells having an electrode substance-filled porous electrolyte layer, obtainable by filling pores of a porous electrolyte layer formed from a electrolyte substance with a porosity of 30 to 70%, and an electrode substance powder, a mixed powder of an electrode substance powder and an electrolyte substance powder, or a composite material powder of an electrode substance and an electrolyte substance.

The present invention (3) provides a cell for solid oxide fuel cells having an electrode substance-filled porous electrolyte layer comprising a porous electrolyte layer formed from an electrolyte substance and an electrode substance powder, a mixed powder of an electrode substance powder and an electrolyte substance powder, or a composite material powder of an electrode substance and an electrolyte substance, filled in the pores of the porous electrolyte layer, the pore volume ratio of the porous electrolyte layer to the apparent volume of the electrode substance-filled porous electrolyte layer being 30 to 70%.

According to the present invention, a process for producing a cell for solid oxide fuel cells which can increase the three-phase interface of the porous electrolyte layer and exhibits only a small conductivity reduction of the electrolyte layer can be obtained.

### BRIEF DESCRIPTION OF THE DRAWINGS

FIG. 1 is a schematic drawing showing a porous electrolyte layer-forming step of the production process according to the present invention.

FIG. 2 is a schematic drawing showing an electrode layer-forming step of the production process according to the present invention.

FIG. 3 is a schematic drawing showing a composite particle powder and an aggregate powder of an electrode substance and an electrolyte substance according to the present invention.

FIG. 4 is an enlarged schematic drawing showing an end face of an electrode substance-packed porous electrolyte layer of the cell for solid oxide fuel cells according to the present invention.

FIG. 5 is a drawing similar to FIG. 4, in which a porous electrolyte layer 46 forming an electrode substance-packed porous electrolyte layer 42 in FIG. 4 is shown shaded.

FIG. 6 is a drawing similar to FIG. 4, in which the area of a void 47 in the electrode substance-filled porous electrolyte layer 42 in FIG. 4 is hatched.

FIG. 7 is a schematic drawing showing a porous electrolyte layer 56.

FIG. 8 is a drawing similar to FIG. 7, in which pores 57 in the porous electrolyte layer 56 are hatched.

FIG. 9 is a side elevation of a constant polarization measuring sample.

FIG. 10 shows a graph showing the results of measuring power generation characteristics of the cell for solid oxide fuel cells.

FIG. 11 is a schematic drawing showing a porous electrolyte layer-forming step in a conventional process for producing a cell for solid oxide fuel cells having a porous electrolyte layer.

FIG. 12 is a schematic drawing showing an electrolyte substrate on which an electrode substance-filled porous electrolyte layer and an electrode layer produced by a conventional process are formed.

### BEST MODE FOR CARRYING OUT THE INVENTION

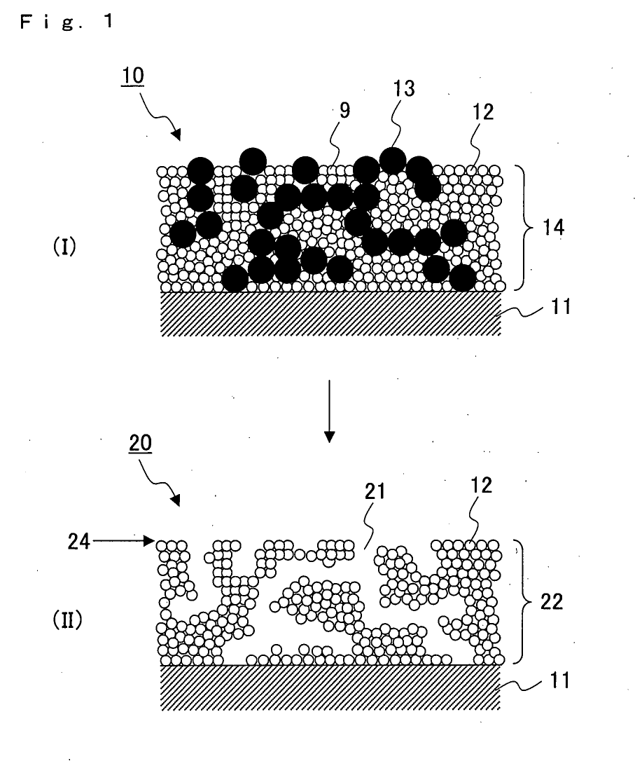

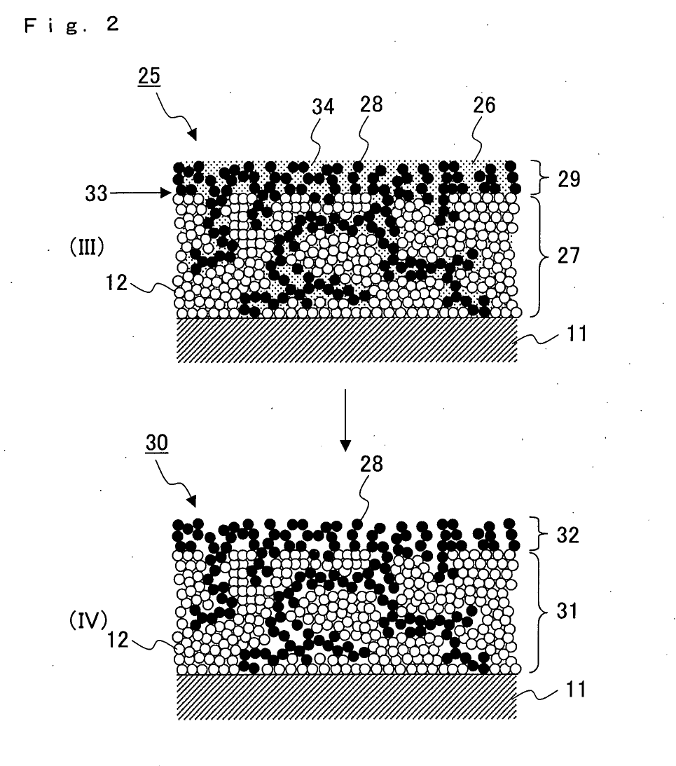

The process for producing the cell for solid oxide fuel cells of the present invention (hereinafter referred to from time to time as “production process of the present invention”) comprises a porous electrolyte layer-forming step and an electrode layer-forming step. The production process of the present invention will be explained with reference to FIGS. 1 and 2. FIG. 1 is a schematic drawing showing the porous electrolyte layer-forming step of the production process of the present invention, which is shown by way of an end view cut along a plane perpendicular to the surface direction of the electrolyte substrate. FIG. 2 is a schematic drawing showing the electrode layer-forming step of the production process of the present invention, which is shown by way of an end view cut along a plane perpendicular to the surface direction of the electrolyte substrate.

An electrolyte substrate 10 on which a slurry layer for forming an electrolyte layer 14 is coated can be obtained by applying a slurry (slurry for forming an electrolyte layer 9) comprising an electrolyte substance powder (a) 12 and a pore-forming agent 13 (a solid component) dispersed in a liquid to one of the surfaces of the electrolyte substrate 11 ((I) in FIG. 1). The liquid component of the slurry layer for forming the electrolyte layer 14 mainly consists of a solvent and a binder component which is dissolved in the solvent. In (I) of FIG. 1, the slurry layer for forming an electrolyte layer 14 fills out the spaces between the electrolyte substance powder (a) 12 and the pore-forming agent 13. In order to distinguish an electrolyte substance powder contained in the slurry for forming electrolyte layers from an electrolyte substance powder contained in the slurry for forming electrode layers mentioned later, the electrolyte substance powder contained in the slurry for forming the electrolyte layers is referred to as an electrolyte substance powder (a) and the electrolyte substance powder contained in the slurry for forming electrode layers is referred to as an electrolyte substance powder (b) in the present invention.

An electrolyte substrate 20 having a porous electrolyte layer 22 formed therein can be obtained by burning the electrolyte substrate 10 coated with a slurry layer for forming an electrolyte layer 14. In this instance, when the pore-forming agent 13 and the liquid component in the slurry layer for forming an electrolyte layer 14 are burnt down, tracks after these materials are burnt become pores 21 ((II) in FIG. 1) and particles of the electrolyte substance powder (a) 12 sinter in the areas in which the particles contact each other.

Then, a slurry in which an electrode substance powder 28 (a solid component) and a liquid component 26 are dispersed (a slurry for forming an electrode layer 34) is applied to a surface 24 of the porous electrolyte layer (surface of the porous electrolyte layer opposite to the surface in contact with the electrolyte substrate 11) of the electrolyte substrate 20 on which the porous electrolyte layer is formed, whereby the pores 21 of the porous electrolyte layer 22 are impregnated with the slurry for forming an electrode layer 34 and a porous electrolyte layer 27 containing the slurry for forming an electrode layer 34 filled therein can be obtained. At the same time, a slurry layer for forming an electrode layer 29 is formed on a surface 33 of the porous electrolyte layer on the opposite side of the electrolyte substrate 11 of the porous electrolyte layer 27 ((III) in FIG. 2). In this way, the electrolyte substrate 25 having the slurry layer for forming an electrode layer 29 coated thereon and containing the porous electrolyte layer formed therein can be obtained. The electrode substance powder 28 is a fuel electrode substance powder when the electrode layer formed on the surface of porous electrolyte layer 22 is a fuel electrode layer, and is an air electrode substance powder when the electrode layer is an air electrode layer.

Then, an electrode substance-filled porous electrolyte layer 31 packed with the electrode substance powder 28 and an electrolyte substrate 30 in which an electrode layer 32 is formed can be obtained by burning the electrolyte substrate 25 in which the porous electrolyte layer is formed ((IV) in FIG. 2). In this instance, the liquid component 26 in the slurry for forming an electrode layer 34 is burnt down, and particles of the electrode substance powder 28, as well as particles of the electrode substance powder 28 and the electrolyte substance powder (a) 12, sinter in the areas in which these particles contact each other.

In this manner, by carrying out the porous electrolyte layer-forming step and the electrode layer-forming step, an electrode substance-filled porous electrolyte layer, in which the electrode substance powder is filled, and an electrode layer (either a fuel electrode layer or an air electrode layer) are formed on one of the surfaces of the electrolyte substrate. Next, another electrode layer (either an air electrode layer or a fuel electrode layer) is formed by carrying out the porous electrolyte layer-forming step and the electrode layer-forming step or by using a known method on the other surface of the electrolyte substrate, thereby obtaining a cell for forming solid oxide fuel cells. It is also possible to first form an electrode layer (either a fuel electrode layer or an air electrode layer) on one of the surfaces of the electrolyte substrate, and then to form an electrode substance-filled porous electrolyte layer, in which the electrode substance powder is filled, and another electrode layer on the other the surface of the electrolyte substrate (either an air electrode layer or a fuel electrode layer) by carrying out the porous electrolyte layer-forming step and the electrode layer-forming step, to obtain a cell for forming solid oxide fuel cells. Furthermore, it is possible to first form an electrode layer (either a fuel electrode layer or an air electrode layer), and then form a dense electrolyte layer on the electrode layer, followed by forming an electrode substance-filled porous electrolyte layer, in which the electrode substance powder is filled, and another electrode layer (either an air electrode layer or a fuel electrode layer) by carrying out the porous electrolyte layer-forming step and the electrode layer-forming step, to obtain a cell for forming solid oxide fuel cells.

Specifically, the production process of the present invention comprises a porous electrolyte layer-forming step for obtaining an electrolyte substrate in which a porous electrolyte layer is formed by applying a slurry for forming an electrolyte layer containing an electrolyte substance powder and a pore-forming agent to the surface of an electrolyte substrate and burning the electrolyte substrate, and an electrode layer-forming step for obtaining an electrolyte substrate in which an electrode substance-filled porous electrolyte layer and an electrode layer are formed by applying a slurry for forming an electrode containing an electrode substance powder, a mixture of an electrode substance powder and an electrolyte substance powder, or a composite material powder of an electrode substance and an electrolyte substance, onto the surface of the porous electrolyte layer of the electrolyte substrate on which the porous electrolyte layer is formed, and burning the electrolyte substrate in which the porous electrolyte layer is formed.

There are no limitations to the electrolyte substance for the electrolyte substance powder (a) used in the production process of the present invention, insofar as the electrolyte substance is a substance usually used for the production of an electrolyte layer of a cell for solid oxide fuel cells. For example, oxides of one or more metals selected from the group consisting of yttrium (Y), zirconium (Zr), scandium (Sc), cerium (Ce), samarium (Sm), aluminum (Al), titanium (Ti), magnesium (Mg), lanthanum (La), gallium (Ga), niobium (Nb), tantalum (Ta), silicon (Si), gadolinium (Gd), strontium (Sr), ytterbium (Yb), iron (Fe), cobalt (Co), and nickel (Ni) can be given. Among the metal oxides forming the electrolyte substance, as oxides containing two or more metals include, for example, scandia-stabilized zirconia (ScSZ; Sc₂O₃—ZrO₂), scandia ceria-stabilized zirconia (10Sc1CeSZ; (10Sc₂O₃.CeO₂)—ZrO₂), yttria-stabilized zirconia (YSZ; Y₂O₃—ZrO₂), lanthanum gallate such as lanthanum strontium magnesium gallate (LSGM; La_{0.8}Sr_{0.2}Ga_{0.8}Mg_{0.2}O₃), gadolinia-stabilized zirconia (Gd₂O₃—ZrO₂), samaria-doped ceria (Sm₂O₃—CeO₂), gadolinia-doped ceria (Gd₂O₃—CeO₂), and yttrium oxide-dispersed bismuth oxide (Y₂O₃—Bi₂O₃) can be given. Of these, scandia-stabilized zirconia, scandia ceria-stabilized zirconia, yttria-stabilized zirconia, lanthanum gallates such as lanthanum strontium magnesium gallate are preferable due to excellent oxygen ion conductivity and thermal stability at operating temperatures. Samaria-doped ceria and gadolinia-doped ceria which possess both ionic conductivity and electronic conductivity can be used not only as the metal oxide of an electrolyte substance, but also as the metal oxide of a fuel electrode substance by mixing with nickel oxide as described later.

The average particle diameter of the electrolyte substance powder (a) is preferably from 0.01 to 3 micrometers, particularly preferably from 0.05 micrometers to 1 micrometer, and still more preferably from 0.1 to 0.7 micrometers. The smaller the average particle diameter of the electrolyte substance powder (a), the larger the number of contact points among the particles of the electrolyte substance powder (a) and the easier it is for the particles of the electrolyte substance powder (a) to become sintered, resulting in an increase in the conductivity of the porous electrolyte layer. However, if the average particle diameter of the electrolyte substance powder (a) is less than 0.01 micrometers, shrinkage of the electrolyte layer during sintering is large, causing the porous electrolyte layer to be easily damaged. If the average particle diameter of the electrolyte substance powder (a) is more than 3 micrometers, the conductivity of the porous electrolyte layer tends to decrease.

There are no specific limitations to the pore-forming agent. Any compounds which are not dissolved in the solvent used for the slurry for forming the electrolyte layer, present as a solid in the slurry, and destructed by burning can be used as the pore-forming agent. As examples of the pore-forming agent, carbon powder, thermoplastic resin powder, thermoplastic resin fibers, thermosetting resin powder, thermosetting resin fibers, natural fibers, and derivatives of natural fibers can be given. As examples of the carbon powder, carbon black, activated carbon, graphite, and amorphous carbon can be given. The content of the metal component in the carbon powder is preferably 100 mg/kg or less. Carbon powder not containing a metal component is particularly preferable. As examples of the thermoplastic resin powder, thermoplastic resin fibers, thermosetting resin powder, and thermosetting resin fibers, hydrocarbon compounds such as polystyrene, or compounds containing atoms other than carbon and hydrogen, such as oxygen-containing organic compounds such as polymethyl methacrylate, a phenol resin, and an epoxy resin, nitrogen-containing compounds such as a polyamide, a melamine resin, a urea resin, and polyurethane, and sulfur-containing compounds such as a polysulfone can be given. Of these, hydrocarbon compounds and oxygen-containing organic compounds which do not generate gases other than carbon dioxide gas during burning are preferable. As examples of the natural fibers, cellulose fibers and protein fibers can be given. The cellulose fibers include semi-artificial acetate and rayon. As examples of derivatives of natural fibers, ethyl esters of natural fibers such as ethyl cellulose can be given.

The pore-forming agent may have a form of particles, fibers, or flakes. Particles include those having a circular cross-section, an elliptical cross-section, a polygonal cross-section, and an infinite cross-section. Fibers include acicular fibers and cylindrical fibers. In the present invention, a configuration with approximately the same diameter in the lengthwise, crosswise, and depth directions is called a powder, a configuration having an extremely large crosswise dimension as compared with the lengthwise dimension and the depth is called a fiber, and a configuration having an extremely small lengthwise dimension as compared with the crosswise dimension and the depth is called a flake. However, they are not necessarily strictly distinguished, nor are their boundaries necessarily strictly defined.

When the pore-forming agent is a particle, the average particle diameter is preferably from 0.1 to 20 micrometers, particularly preferably from 0.5 to 10 micrometers, and still more preferably from 1 micrometer to 5 micrometers. If the average particle diameter of the pore-forming agent is less than 0.1 micrometers, since the pore diameter of the porous electrolyte layer is too small, it is difficult for the pores to be impregnated with the slurry for forming the electrode layer, and if more than 20 micrometers, since the pore volume of the porous electrolyte layer is too large, the conductivity of the porous electrolyte layer tends to decrease. In the case of particles, the average particle diameter of the particulate pore-forming agent refers to the average of the largest dimension among the lengthwise, crosswise, and depth directions of each particle.

When the pore-forming agent is fibrous, the average fiber diameter of the pore-forming agent is preferably from 0.01 to 10 micrometers, particularly preferably from 0.05 to 5 micrometers, and still more preferably from 0.1 micrometers to 1 micrometer. If the average fiber diameter of the pore-forming agent is less than 0.1 micrometers, since the pore diameter of the porous electrolyte layer is too small, it is difficult for the pores to be impregnated with the slurry for forming the electrode layer, and if more than 10 micrometers, since the pore volume the porous electrolyte layer is too large, the conductivity of the porous electrolyte layer tends to decrease. Although not specifically limited, the average fiber diameter of the pore-forming agent is preferably from 0.001 micrometers to 1 micrometer, and particularly preferably from 0.005 micrometers to 0.5 micrometers. In the case of fibers, the average fiber length refers to the average of the crosswise dimension of each fiber, and the average fiber diameter refers to an average of the larger dimension of the lengthwise direction and the depth direction of each particle.

When the pore-forming agent is flake, the average diameter of the pore-forming agent is preferably from 0.1 to 20 micrometers, particularly preferably from 0.5 to 10 micrometers, and still more preferably from 1 micrometer to 5 micrometers. If the average diameter of the pore-forming agent is less than 0.1 micrometers, since the pore diameter of the porous electrolyte layer is too small, it is difficult for the pores to be impregnated with the slurry for forming the electrode layer, and if more than 20 micrometers, since the pore volume of the porous electrolyte layer is too large, the conductivity of the porous electrolyte layer tends to decrease. In the case of flakes, the average diameter of the flaky pore-forming agent refers to the average of the larger dimension of the crosswise direction and the depth direction of each particle.

The ratio of the average diameter of the pore-forming agent to the average particle diameter of the electrolyte substance powder (a) (average diameter of pore-forming agent/average particle diameter of electrolyte substance powder (a)) is preferably from 2 to 1,000, particularly preferably from 4 to 100, and still more preferably from 5 to 20. If the ratio of the average diameter of the pore-forming agent to the average particle diameter of the electrolyte substance powder (a) is in the above range, the conductivity of the porous electrolyte layer is high. When the pore-forming agent is a fiber, this ratio is determined taking the average fiber length as the average diameter of the pore-forming agent.

The slurry for forming the electrolyte layer contains the electrolyte substance powder (a) and the pore-forming agent and can be prepared by dispersing the electrolyte substance powder (a) and the pore-forming agent in the liquid component of the slurry. The liquid component of the slurry comprises an organic solvent, a binder component dissolved in the organic solvent, and the like.

The volume ratio of the electrolyte substance powder (a) to the pore-forming agent (electrolyte substance powder (a)/pore-forming agent) is preferably from 0.1 to 10, particularly preferably from 0.3 to 3, and still more preferably from 0.66 to 1.5. If the volume ratio of the electrolyte substance powder (a) to the pore-forming agent is less than 0.1, the conductivity of the porous electrolyte layer tends to decrease, and if more than 10, since the volume of the pores in which the electrode substance powder is filled decreases, it is difficult to increase the amount of the three-phase interface.

The slurry for forming the electrolyte layer may contain a binder component which functions as a binder when dissolved in a solvent such as a polyvinyl butyral resin and an ethyl cellulose, a plasticizer component which functions as a plasticizer when dissolved in a solvent such as n-butyl phthalate, a dispersant component such as a nonionic dispersant, and a deformer component such as octyl phenyl ether. The binder component, the plasticizer component, the dispersant component, and the deformer component are dissolved in the liquid component of the slurry for forming the electrolyte layer.

The viscosity of the slurry for forming the electrolyte layer is preferably from 1,000 to 50,000 mPa·s, particularly preferably from 3,000 to 20,000 mPa·s, and still more preferably from 6,000 to 12,000 mPa·s. The viscosity of the slurry for forming the electrolyte layer can be adjusted by evaporating the solvent in the slurry for forming the electrolyte layer using an evaporator or the like.

The electrolyte substrate is not particularly limited insofar as the substrate is made from an electrolyte substance in a dense structure that does not allow gas permeation. The electrolyte substrate can be obtained by a known method of producing an electrolyte layer such as a screen printing method. The same type of electrolyte substances used as the electrolyte substance powder (a) can be used for preparing the electrolyte substrate. The electrolyte substrate may have an electrode layer (either a fuel electrode layer or an air electrode layer) formed on the surface opposing the surface on which the electrode substance-filled porous electrolyte layer and the electrode layer (either an air electrode layer or a fuel electrode layer) are formed.

There are no limitations to the method of applying the slurry for forming an electrolyte layer to the electrolyte substrate. For example, a screen-printing method and a doctor plate method can be given. As required, the electrolyte substrate can be dried after applying the slurry for forming an electrolyte layer.

The thickness of the slurry layer for forming an electrolyte layer applied to the electrolyte substrate (the thickness of the slurry layer for forming an electrolyte layer 14 in FIG. 1) is preferably from 1 micrometer to 100 micrometers, particularly preferably from 5 to 30 micrometers, and still more preferably from 10 to 20 micrometers. If the thickness of the slurry layer for forming an electrolyte layer is less than 1 micrometer, the amount of the three-phase interface formed in the porous electrolyte layer tends to decrease, and if more than 100 micrometers, the conductivity of the porous electrolyte layer tends to decrease. The thickness of the electrode substance-filled porous electrolyte layer (thickness of the electrode substance-filled porous electrolyte layer 31 in FIG. 2) is determined according to the thickness of the slurry layer for forming an electrolyte layer.

The baking temperature in the electrolyte layer-forming step is usually from 1,200° C. to 1,550° C., preferably from 1,300° C. to 1,450° C., and particularly preferably from 1,350° C. to 1,450° C. The baking time is usually from 1 to 20 hours, preferably from 3 to 10 hours, and particularly preferably from 4 to 8 hours. By the baking operation, the pore-forming agent and the liquid component are burned down and particles of the electrolyte substance powder (a) are sintered among themselves, whereby the porous electrolyte layer is formed.

The electrode substance powder used for forming a fuel electrode layer on the surface of the porous electrolyte layer differs from the mixed powder used for forming an air electrode layer on the surface of the porous electrolyte layer. When forming a fuel electrode layer, a fuel electrode substance powder is used, and when forming an air electrode layer, an air electrode substance powder is used.

There are no limitations to the fuel electrode substance used as the fuel electrode substance powder in the production process of the present invention inasmuch as the substance is commonly used for producing a fuel electrode layer of a cell for solid oxide fuel cells. For example, an oxide of one or more metals selected from the group consisting of yttrium, zirconium, scandium, cerium, samarium, aluminum, titanium, magnesium, lanthanum, gallium, niobium, tantalum, silicon, gadolinium, strontium, ytterbium, iron, cobalt, nickel, and calcium (Ca) can be given. As examples of the metal oxide containing two or more types of metals among the metal oxides forming the fuel electrode substance, an aggregate of a mixture of nickel oxide (NiO) and the samaria-doped ceria (Sm₂O₃—CeO₂); an aggregate of a mixture of nickel oxide and yttria-stabilized zirconia (NiO-YSZ); an aggregate of a mixture of nickel oxide and scandia-stabilized zirconia (NiO—ScSZ); an aggregate of a mixture of nickel oxide, yttria-stabilized zirconia, and samaria-doped ceria; an aggregate of a mixture of nickel oxide, scandia-stabilized zirconia, and samaria-doped ceria; an aggregate of a mixture of nickel oxide, yttria-stabilized zirconia, and ceria oxide (CeO₂); an aggregate of a mixture of nickel oxide, scandia-stabilized zirconia, and ceria oxide; an aggregate of a mixture of cobalt oxide (Co₃O₄) and yttria-stabilized zirconia; an aggregate of a mixture of cobalt oxide and scandia-stabilized zirconia; an aggregate of a mixture of ruthenium oxide (RuO₂) and yttria-stabilized zirconia; an aggregate of a mixture of ruthenium oxide and scandia-stabilized zirconia; and an aggregate of a mixture of nickel oxide and gadolinia-doped ceria (Gd₂O₃—CeO₂) can be given. Among these, an aggregate of a mixture of nickel oxide and samaria-doped ceria, an aggregate of a mixture of nickel oxide, and yttria-stabilized zirconia, and an aggregate of a mixture of nickel oxide and scandia-stabilized zirconia are preferable owing to their properties of not reacting with electrolyte substances and the capability of being easily bonded to electrolyte substances due to their close coefficients of thermal expansion.

There are no limitations to the air electrode substance used as the air electrode substance powder in the production process of the present invention inasmuch as the substance is commonly used for producing an air electrode layer of a cell for solid oxide fuel cells. For example, an oxide of one or more metals selected from the group consisting of yttrium, zirconium, scandium, cerium, samarium, aluminum, titanium, magnesium, lanthanum, gallium, niobium, tantalum, silicon, gadolinium, strontium, ytterbium, iron, cobalt, nickel, calcium, and manganese (Mn) can be given. As examples of metal oxides containing two or more types of metals among the metal oxides forming the air electrode substance, lanthanum strontium manganate (La_{0.8}Sr_{0.2}MnO₃), lanthanum calcium cobaltate (La_{0.9}Ca_{0.1}CoO₃), lanthanum strontium cobaltate (La_{0.9}Sr_{0.1}CoO₃), lanthanum cobaltate (LaCoO₃), lanthanum calcium manganate (La_{0.9}Ca_{0.1}MnO₃), and the like can be given. Of these oxides, lanthanum strontium manganate is preferable owing to its properties of not reacting with electrolyte substances and capability of being easily bonded to electrolyte substances due to their close coefficients of thermal expansion.

In the production process of the present invention, the mixed powder is a mixture of the electrode substance powder and the electrolyte substance powder (b). The mixed powder used for forming a fuel electrode layer on the surface of the porous electrolyte layer differs from the mixed powder used for forming an air electrode layer on the surface of the porous electrolyte layer. When forming a fuel electrode layer, the mixed powder is a mixture of the fuel electrode substance powder and the electrolyte substance powder (b), and when forming an air electrode layer, the mixed powder is a mixture of the air electrode substance powder and the electrolyte substance powder (b). The slurry for forming the electrode layer is preferably a slurry containing the mixed powder in order to ensure a high output of the fuel cell. When the slurry for forming an electrode layer is a slurry containing a mixture of the electrode substance powder and the electrolyte substance powder (b), the volume ratio of the electrolyte substance powder (b) to the electrode substance powder (electrolyte substance powder (b)/electrode substance powder) is from 0.1 to 2, preferably from 0.5 to 1.5, and particularly preferably from 0.6 to 1.0. The volume ratio in the above range ensures a high output of the fuel cell. The same type of electrolyte substances used as the electrolyte substance powder (a) can be used for the electrolyte substance powder (b).

The composite powder of the electrode substance and the electrolyte substance is an aggregate of particles formed from an electrode substance and an electrolyte substance. Specifically, each particles of the composite powder of the electrode substance and the electrolyte substance is made from both of the electrode substance and the electrolyte substance. As examples of the composite material powder of the electrode substance and the electrolyte substance, composite particle powder comprising mother particles and child particles fixed to the mother particles, and an aggregate powder of an electrode substance and an electrolyte substance can be given. The composite particle powder and the aggregate powder of the electrode substance and the electrolyte substance will be explained with reference to FIG. 3. FIG. 3 is a schematic drawing showing a composite particle powder and an aggregate powder of the electrode substance and the electrolyte substance according to the present invention. In FIG. 3, composite particles 35 comprises one or more child particles 37 fixed to the surface of mother particles 36 ((A) in FIG. 3). In the composite particles 35 comprising the mother particles 36 and the child particles 37, when the electrode layer formed on the surface of the porous electrolyte layer is a fuel electrode layer, the mother particles 36 are an electrolyte substance and the child particles 36 are a fuel electrode substance, or the mother particles 36 are a fuel electrode substance and the child particles 36 are an electrolyte substance. In the composite particles 35 comprising the mother particles 36 and the child particles 37, when the electrode layer formed on the surface of the porous electrolyte layer is an air electrode layer, the mother particles 36 are an electrolyte substance and the child particles 37 are an air electrode substance, or the mother particles 36 are an air electrode substance and the child particles 37 are an electrolyte substance. The same type of electrolyte substances used as the electrolyte substance powder (a) can be used as the electrolyte substance of the composite particle powder, the same type of fuel electrode substances used as the fuel electrode substance powder can be used as the fuel electrode substance of the composite particle powder, and the same type of air electrode substances used as the air electrode substance powder can be used as the air electrode substance of the composite particle powder. There are no specific limitations to the composite particle powder insofar as the composite particle powder are those commonly used for producing an electrode for solid oxide fuel cells.

In FIG. 3, the aggregate 39 of an electrode substance and an electrolyte substance is an aggregate (secondary particles) made from aggregation of an electrode substance 381 and an electrolyte substance 382, which are the primary particles ((B) in FIG. 3). The electrode substance 381 used in the aggregate 39 of an electrode substance and an electrolyte substance is a fuel electrode substance when the electrode layer formed on the surface of the porous electrolyte layer is a fuel electrode layer, and an air electrode substance when the electrode layer formed on the surface of the porous electrolyte layer is an air electrode layer. The same type of electrolyte substances used as the electrolyte substance powder (a) can be used as the electrolyte substance of the powdery aggregate of the electrode substance and the electrolyte substance, the same type of fuel electrode substances used as the fuel electrode substance powder can be used as the fuel electrode substance of the powdery aggregate of the electrode substance and the electrolyte substance, and the same type of air electrode substances used as the air electrode substance powder can be used as the air electrode substance of the powdery aggregate of the electrode substance and the electrolyte substance.

The average particle diameter of the electrode substance powder, the mixed powder of the electrode substance powder and the electrolyte substance powder (b), and the composite particle powder of the electrode substance and the electrolyte substance is preferably from 0.001 to 10 micrometers, particularly preferably from 0.005 micrometers to 1 micrometer, and still more preferably from 0.01 to 0.5 micrometers. The smaller the average particle diameter, the easier it is for the electrode substance powder, the mixed powder of the electrode substance powder and the electrolyte substance powder (b), and the composite particle powder of the electrode substance and the electrolyte substance to be filled in the said porous electrolyte layer, the larger is the amount of the three-phase interface, and the easier it is for the particles to become sintered among themselves. Therefore, it is possible to increase the conductivity of the electrode layer. However, if the average particle diameter is less than 0.001 micrometers, excessive sintering among the particles tends to occur, resulting in a decrease in the surface area of the electrode layer. If the average particle diameter is more than 10 micrometers, the amount of the electrode substance powder, the mixed powder of the electrode substance powder and the electrolyte substance powder (b), and the composite particle powder of the electrode substance and the electrolyte substance filled in the pores of the porous electrolyte layer tends decrease. In the case of the composite particle powder of the electrode substance and the electrolyte substance, the average diameter of the mother particles is deemed to be the average diameter of the particles of the composite particle powder of the electrode substance and the electrolyte substance.

Although not specifically limited, when the composite powder of the electrode substance and the electrolyte substance is the composite particles, the ratio of the content of the average particle diameter of child particles to the average particle diameter of mother particles (child particles/mother particles) is preferably from 0.001 to 1.0, and particularly preferably from 0.01 to 0.1.

The ratio of the average particle diameter of the electrode substance powder, a mixed powder of the electrode substance powder and the electrolyte substance powder (b), or the composite particle powder of the electrode substance and the electrolyte substance contained in the slurry for forming the electrode layer to the average pore diameter of the pore-forming agent (average particle diameter of the electrode substance powder, a mixed powder of the electrode substance powder and the electrolyte substance powder (b), or the composite particle powder of the electrode substance and the electrolyte substance/average particle diameter of pore-forming agent) is preferably from 0.001 to 1, particularly preferably from 0.001 to 0.1, and still more preferably 0.001 to 0.01. The ratio of the average particle diameter in the above range ensures that the electrode substance powder, the mixed powder of the electrode substance powder and the electrolyte substance powder (b), or the composite particle powder of the electrode substance and the electrolyte substance is easily filled in the porous electrolyte layer, and thus increases the amount of the three-phase interface.

The composite particle powder can be produced by a method known in the art using a mother particle powder of an electrolyte substance and a child particle powder of a fuel electrode substance, a mother particle powder of a fuel electrode substance and a child particle powder of an electrolyte substance, a mother particle powder of an electrolyte substance and a child particle powder of an air electrode substance, or a mother particle powder of an air electrode substance and a child particle powder of an electrolyte substance. The aggregate powder of the electrode substance and the electrolyte substance can be produced, for example, by a method commonly called spray pyrolysis comprising spraying droplets of an aqueous solution containing a metal ion into a heating furnace to obtain and aggregate powder of a metal oxide, wherein an aqueous solution containing both a metal ion of the metal which is converted into an electrode substance by oxidation reaction and a metal ion of the metal which is converted into an electrolyte substance by an oxidation reaction is used as the aqueous solution to be sprayed.

The slurry for forming the electrolyte layer contains the electrode substance powder, a mixed powder of the electrode substance powder and the electrolyte substance powder (b), or the composite powder of the electrode substance and the electrolyte substance and can be obtained by dispersion of the electrode substance powder, a mixed powder of the electrode substance powder and the electrolyte substance powder (b), or the composite particle powder of the electrode substance and the electrolyte substance in the liquid component of the slurry. The liquid component of the slurry comprises an organic solvent, a binder component dissolved in the organic solvent, and the like.

The slurry for forming the electrode layer may include a binder component, a plasticizer component, a dispersant component, or a defoaming component. The binder component, plasticizer component, dispersant component, and defoaming component used in the slurry for forming the electrode layer are the same as those used in the slurry for forming the electrolyte layer.

The viscosity of the slurry for forming the electrode layer is preferably from 1,000 to 50,000 mPa·s, particularly preferably from 3,000 to 20,000 mPa·s, and still more preferably from 3,000 to 12,000 mPa·s. The viscosity of the slurry for forming the electrode layer can be adjusted by evaporating the solvent in the slurry for forming the electrode layer using an evaporator or the like. The smaller the viscosity of the slurry for forming the electrode layer, the easier it is for the pores of the porous electrolyte layer to be impregnated with the slurry for forming the electrode layer. If the viscosity of the slurry for forming the electrode layer is less than 1,000 mPa·s, it is difficult for the slurry layer for forming the electrode layer 29 to maintain its shape after application, and if the viscosity is more than 50,000 mPa·s, it is difficult for the pores of the porous electrolyte layer to be impregnated with the slurry for forming the electrode layer.

There are no specific limitations to the method of applying the slurry for forming an electrode layer on the surface of the porous electrolyte layer of an electrolyte substrate on which the electrolyte layer is formed (the surface opposite the surface in contact with the electrolyte substrate). For example, a screen-printing method and a doctor plate method can be given. As required, the electrolyte substrate on which the porous electrolyte layer has been formed can be dried after applying the slurry for forming an electrode layer.

The thickness of the slurry layer 29 for forming an electrode layer is preferably from 5 to 2,000 micrometers, particularly preferably from 10 to 500 micrometers, and still more preferably from 10 to 100 micrometers, when the electrode layer after formation functions as a supporting member, and preferably from 3 to 2,000 micrometers, particularly preferably from 10 to 100 micrometers, and still more preferably from 10 to 50 micrometers, when the electrode layer after formation does not function as a supporting member.

The baking temperature in the electrode layer-forming step is usually from 1,100° C. to 1,600° C., preferably from 1,100° C. to 1,500° C., and particularly preferably from 1,100° C. to 1,400° C. The baking time is usually from 1 to 20 hours, preferably from 3 to 10 hours, and particularly preferably from 3 to 8 hours. In the baking step, the liquid component in the slurry for forming the electrode layer is burnt down and, at the same time, the electrode substance powder, the electrolyte substance powder (b), or the composite powder of the electrode substance and the electrolyte substance are sintered to produce an electrode substance-filled porous electrolyte layer and an electrode layer filled with the electrode substance powder, the mixed powder of the electrode substance powder and the electrolyte substance powder (b), or the composite particle powder of the electrode substance and the electrolyte substance.

Since the diameter of pores formed in the porous electrolyte layer can be controlled, pores having the necessary diameter for filling of the electrode substance powder, the mixed powder of the electrode substance powder and the electrolyte substance powder (b), or the composite particle powder of the electrode substance and the electrolyte substance can be surely formed according to the production process of the present invention. For this reason, as compared with a porous electrolyte layer of conventional cells for solid oxide fuel cells which can be produced without using a pore-forming agent, the porous electrolyte layer of the cell for solid oxide fuel cells obtained by the production process of the present invention contains a large amount of the electrode substance powder, the mixed powder of the electrode substance powder and the electrolyte substance powder (b), or the composite particle powder of the electrode substance and the electrolyte substance.

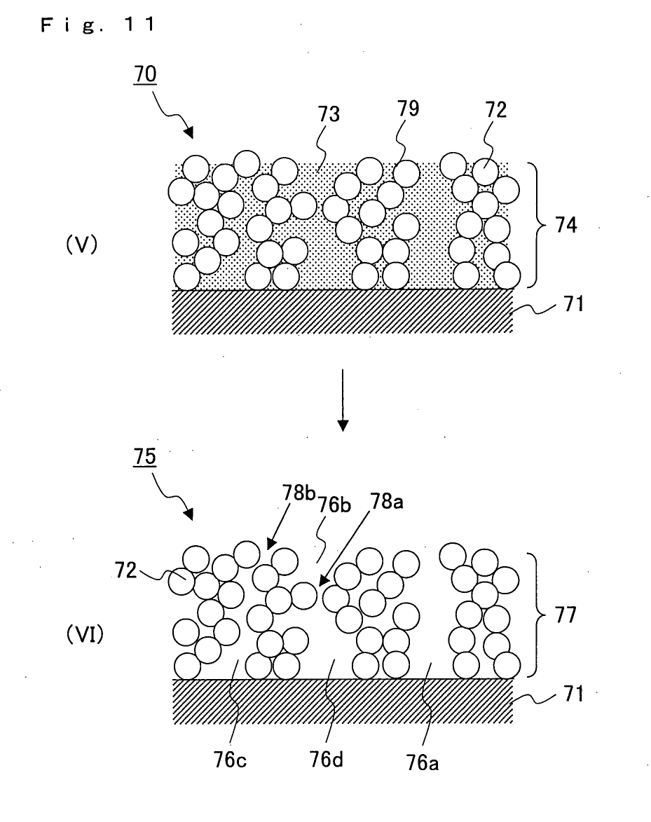

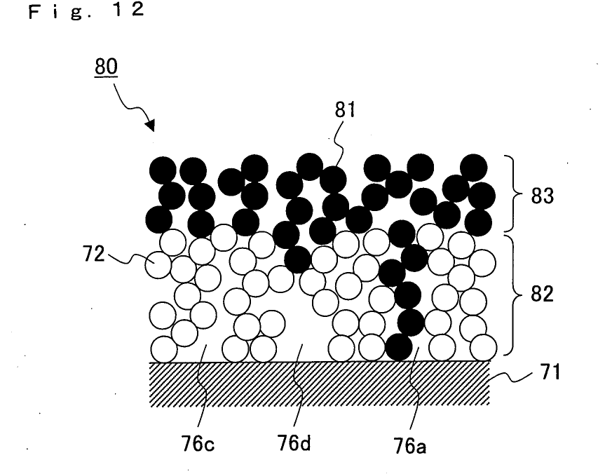

The effect of the production process of the present invention will be explained by showing differences with a conventional production process by reference to FIGS. 1, 2, 11, and 12. FIG. 11 is a schematic drawing showing the porous electrolyte layer-forming step of a conventional process for producing a cell for solid oxide fuel cells having a porous electrolyte layer (hereinafter referred to from time to time as “the conventional production process”), for example, a porous electrolyte layer-forming step in the production process described in JP-A-3-147264, shown by way of an end view cut along a plane perpendicular to the surface direction of the electrolyte substrate.

FIG. 12 is a schematic drawing showing an electrolyte substrate on which an electrode substance-filled porous electrolyte layer and an electrode layer are formed by a conventional production process, shown by way of an end view cut along a plane perpendicular to the surface direction of the electrolyte substrate. In the conventional production process, an electrolyte substrate 70 coated with a slurry layer 74 containing the electrolyte substance powder can be obtained by applying a slurry 79 containing an electrolyte substance powder 72 to an electrolyte substrate 71 ((V) in FIG. 11). The slurry layer 74 is formed from a solid component such as the electrolyte substance powder 72 and a liquid component 73 in which a binder component such as polyvinyl butyral is dissolved. The liquid component 73 is burnt down by baking the electrolyte substrate 70, whereby an electrolyte substrate 75 on which a porous electrolyte layer 77 is formed can be obtained ((VI) in FIG. 11). Next, a slurry containing an electrode substance powder 81 is applied to the surface of the porous electrolyte layer to cause the pores in the porous electrolyte layer 77 to be impregnated with the slurry containing an electrode substance powder 81 and, at the same time, to form a slurry layer on the surface of the porous electrolyte layer 77. Then, the electrolyte substrate 75 on which the porous electrolyte layer is formed is baked to obtain an electrolyte substrate 80 in which an electrode substance-filled porous electrolyte layer 82 filled with the electrode substance powder 81 and an electrode layer 83 are formed (FIG. 12).

In the conventional production process, in order to increase the pore volume in the porous electrolyte layer 77, the ratio of the amount of the liquid component 73 (specifically, binder component and solvent) to the amount of the electrolyte substance powder 72 must be increased. As shown in FIG. 11(V), although the liquid component 73 fills the space in the electrolyte substance powder 72 in the slurry 74, the shape is not necessarily fixed and cannot be controlled since the slurry is a liquid. Since the liquid component 73 becomes pores 76 of the porous electrolyte layer 77 after burning down, the pore shape, specifically the diameter of pores, cannot be controlled in the conventional production process, areas in which the pore diameter is extremely small occur as shown in FIG. 11 (VI) (for example, 78a and 78b). When the slurry containing the electrode substance powder 81 is applied to the porous electrolyte layer 77, if the diameter of pores is larger than the particle diameter of the electrode substance powder 81 like the pores 76a and 76b all through the area, all of pores 76a and 76b are impregnated with the slurry containing such an electrode substance powder. However, if there are areas, like pores 76c and 76d, in which the pore diameter is smaller than the particle diameter of the electrode substance powder 81 (78a and 78b), inside the pores 76c and 76d is not impregnated with the slurry. For this reason, there are pores (pores 76c and 76d) which are not involved in any way with an increase of the three-phase interface in the electrode substance-filled porous electrolyte layer 82 in which the electrode substance powder 81 is filled. Therefore, in the conventional production process, an adverse effect due to an increase of pores in the porous electrolyte layer was larger than the favorable effect obtained by increasing the three-phase interface by increasing the pore volume. Namely, an adverse effect due to reduction of the conductivity of the porous electrolyte layer was more conspicuous.

On the other hand, in the production process of the present invention, the shape of pores in the porous electrolyte layer 22 can be controlled by adding the solid pore-forming agent 13 to the slurry for forming the electrolyte layer 9. Specifically, the pore-forming agent 13 is present in the space among the particles of the electrolyte substance powder (a) 12 in the slurry for forming the electrolyte layer 9, and since the pore-forming agent 13 is a solid material, the intervals between the particles of the electrolyte substance powder (a) 12 in the area in which the pore-forming agent 13 is present is not less than the diameter of the pore-forming agent 13. For this reason, since the intervals of particles of the electrolyte substance powder (a) 12, that is, the pore size after sintering, can be larger than the diameter of the pore-forming agent 13, pores possessing a diameter necessary for the electrode substance powder 28 to be filled therein can be surely formed. This ensures that all of the pores 21 of the porous electrolyte layer 22 are impregnated with the slurry for forming an electrode layer 34, whereby the electrode substance-filled porous electrolyte layer 31 containing the electrode substance powder 28 filled therein can be obtained all over the inside of the pores in the porous electrolyte layer. Specifically, since most pores of the porous electrolyte layer can participate in formation of the three-phase interface according to the production process of the present invention, the amount of the three-phase interface can be increased as compared with conventional production methods. Therefore, in the production process of the present invention, the favorable effect obtained by increasing the three-phase interface is larger than the adverse effect of a conductivity reduction due to an increase of the pore volume.

In addition, in the production process of the present invention, it is possible to form the porous electrolyte layer 22 using an electrolyte substance powder (a) 12 having a particle diameter smaller than pore diameter of the porous electrolyte layer 22 by using an electrolyte substance powder (a) 12 having an average particle diameter smaller than the average pore diameter of the pore-forming agent 13. Such a porous electrolyte layer 22 has an increased number of contact points among the particles of the electrolyte substance powder (a) 12 per unit volume (an apparent volume including the volume of the pores) and makes it easier for the particles of the electrolyte substance powder (a) 12 to sinter among themselves. Therefore, the conductivity of the porous electrolyte layer can be increased.

The cell for solid oxide fuel cells of the present invention has an electrode substance-filled porous electrolyte layer comprising a porous electrolyte layer formed from a electrolyte substance, the pore volume ratio of the porous electrolyte layer to the apparent volume of the electrode substance-filled porous electrolyte layer being 30 to 70%, and an electrode substance powder, a mixed powder of an electrode substance powder and an electrolyte substance powder (d), or a composite material powder of an electrode substance and an electrolyte substance, filled in the pores of the porous electrolyte layer. In order to distinguish an electrolyte substance powder forming the porous electrolyte layer from the electrolyte substance powder filled in the pores of the porous electrolyte layer, the electrolyte substance powder forming the porous electrolyte layer is referred to as an electrolyte substance powder (c) and the electrolyte substance powder filled in the pores of the porous electrolyte layer is referred to as an electrolyte substance powder (d) in the present invention.

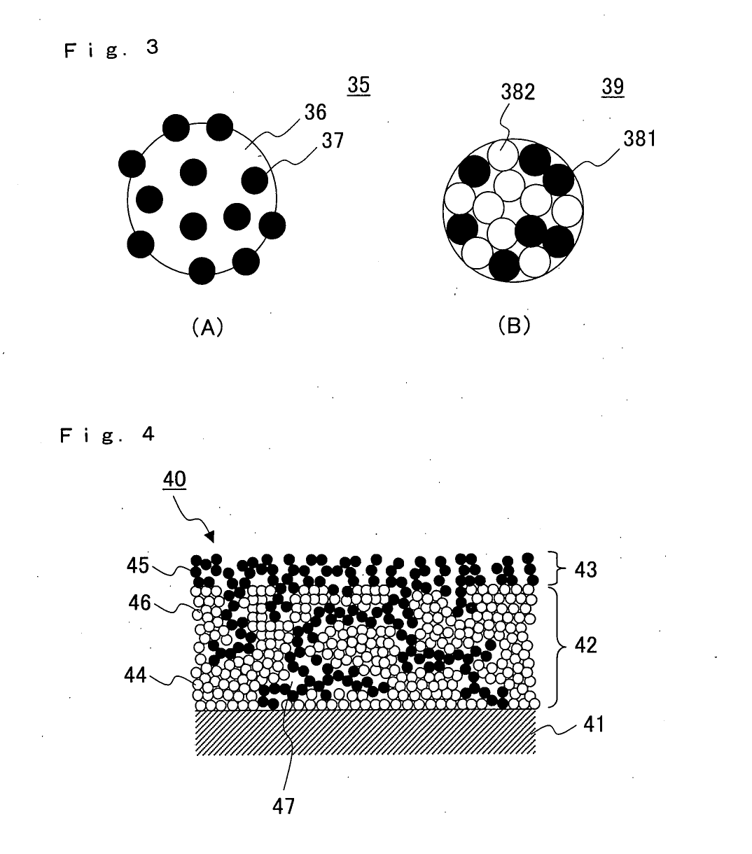

The cell for solid oxide fuel cells of the present invention will be explained with reference to FIG. 4. FIG. 4 is an enlarged schematic drawing showing an end face of an electrode substance-filled porous electrolyte layer of the cell for solid oxide fuel cells according to the present invention. As shown in FIG. 4, a cell for solid oxide fuel cells 40 has an electrode substance-filled porous electrolyte layer 42 consisting of an porous electrolyte layer 46 and an electrode substance powder 45 filled in the pores of the porous electrolyte layer 46. The electrode substance-filled porous electrolyte layer 42 is formed on the surface of an electrolyte substrate 41, and an electrode layer 43 is formed on the surface of the electrode substance-filled porous electrolyte layer 42 opposing the surface in contact with the electrolyte substrate 41.

The porous electrolyte layer 46 constituting the electrode substance-filled porous electrolyte layer 42 is formed from an electrolyte substance powder (c) 44.

In the cell for solid oxide fuel cells of the present invention, the same types of electrolyte substances used as the electrolyte substance powder (a) in the above-mentioned production process can be used as the electrolyte substance powder (c) 44.

The average particle diameter of the electrolyte substance powder (c) 44 is preferably from 0.01 to 3 micrometers, particularly preferably from 0.05 micrometers to 1 micrometer, and still more preferably from 0.1 to 0.7 micrometers. The smaller the average particle diameter of the electrolyte substance powder (c), the larger the number of contact points among the particles of the electrolyte substance powder (c) and the easier it is for the particles of the electrolyte substance powder (c) to become sintered, resulting in an increase in the conductivity of the electrode substance-filled porous electrolyte layer. However, if the average particle diameter of the electrolyte substance powder (c) is less than 0.01 micrometers, shrinkage of the porous electrolyte layer during sintering is large, making it difficult to prepare the porous electrolyte layer or making damage to the porous electrolyte layer easier. If the average particle diameter of the electrolyte substance powder (c) is more than 3 micrometers, the conductivity of the electrode substance-filled porous electrolyte layer tends to decrease.

The porous electrolyte layer 46 is porous and has pores. The volume ratio of the pores of the porous electrolyte layer 46 to the apparent volume of the electrode substance-filled porous electrolyte layer 42 is from 30 to 70%, preferably from 35 to 60%, and particularly preferably from 40 to 50%. If the volume ratio of the pores of the porous electrolyte layer 46 is less than 30%, the output of the fuel cell is low, and if more than 70%, the output of the fuel cell is low or the mechanical strength of the electrode substance-filled porous electrolyte layer is poor. The apparent volume of the electrode substance-filled porous electrolyte layer 42 refers to the volume of the electrode substance-filled porous electrolyte layer 42 including a void 47 (FIG. 4) of the electrode substance-filled porous electrolyte layer 42, that is, including the volume of the pores of the porous electrolyte layer 46 in which the electrode substance powder 45 is not filled. The volume of the porous electrolyte layer 46 refers to the volume of the pores formed in the porous electrolyte layer 46, which is the total of the volume of the electrode substance powder 45 and the volume of the void 47.

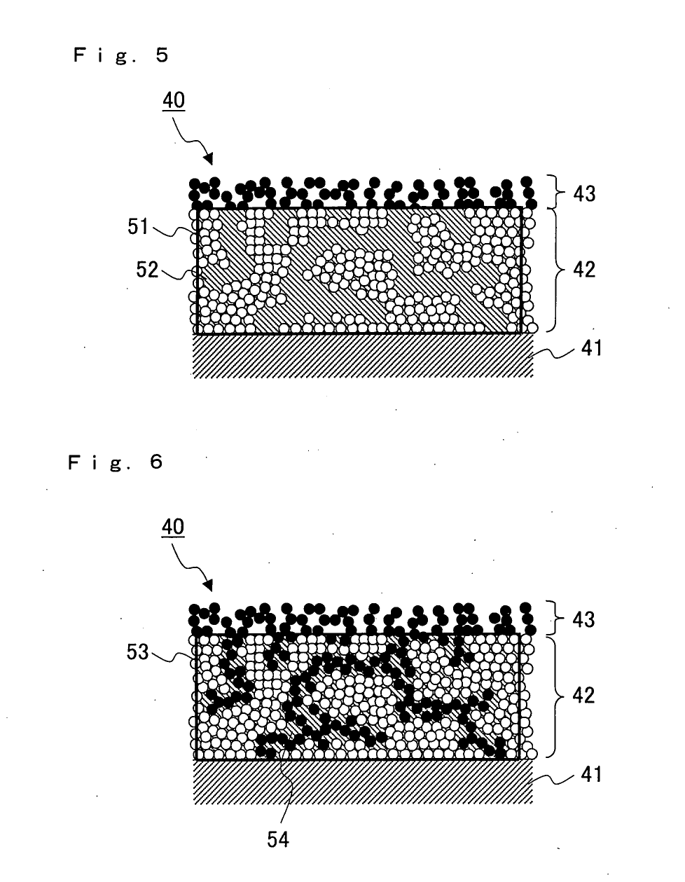

The volume ratio of the pores of the porous electrolyte layer 46 to the apparent volume of the electrode substance-filled porous electrolyte layer 42 in the present invention can be determined by cutting the electrode substance-filled porous electrolyte layer 42 along the plane perpendicular to the surface of the electrolyte substrate 41 on which the electrode substance-filled porous electrolyte layer 42 is formed, and determining the percentage of the cross-sectional area of the pores of the porous electrolyte layer 46 to the apparent cross-sectional area of the electrode substance-filled porous electrolyte layer 42 on an arbitrary cross-section. A specific method of determining the volume ratio of the pores of the porous electrolyte layer 46 to the apparent volume of the electrode substance-filled porous electrolyte layer 42 will be explained with reference to FIG. 5. FIG. 5 is a drawing similar to FIG. 4, in which the porous electrolyte layer 46 constituting the electrode substance-filled porous electrolyte layer 42 in FIG. 4 is shown hatched. First, the electrode substance-filled porous electrolyte layer 42 is cut along an arbitrary plane perpendicular to the surface of the electrolyte substrate 41 on which the electrode substance-filled porous electrolyte layer 42 is formed. Then, the section of the electrode substance-filled porous electrolyte layer 42 in an SEM photograph obtained is surrounded by a frame to determine the area in a frame-encircled region 51 (the part surrounded by the solid line in FIG. 5). Next, the area of the pore cross-section 52 (the hatched part in the frame-encircled region 51 in FIG. 5) of the pores of the porous electrolyte layer 46 is determined. The volume ratio of the pores of the porous electrolyte layer 46 to the apparent volume of the electrode substance-filled porous electrolyte layer 42 is calculated using the following formula (1).

Volume ratio of pores of porous electrolyte layer 46 to apparent volume of electrode substance-filled porous electrolyte layer 42(%)=(area of pore cross-section 52)/(area in frame-encircled region 51)×100 (1)

The volume ratio of the pores of the porous electrolyte layer 46 to the apparent volume of the electrode substance-filled porous electrolyte layer 42 is calculated at least at three places, and the average is regarded as the volume ratio of the pores of the porous electrolyte layer to the apparent volume of the electrode substance-filled porous electrolyte layer of the cell for solid oxide fuel cells of the present invention.

The porosity of the electrode substance-filled porous electrolyte layer 42 is from 20 to 60%, preferably from 25 to 50%, and particularly preferably from 30 to 40%. If the porosity of the electrode substance-filled porous electrolyte layer is less than 20%, the output of the fuel cell is low, and if more than 60%, the mechanical strength of the electrode substance-filled porous electrolyte layer tends to become poor. The porosity of the electrode substance-filled porous electrolyte layer 42 refers to the volume ratio of the void 47 to the apparent volume of the electrode substance-filled porous electrolyte layer 42.

In the present invention, the porosity ratio of the electrode substance-filled porous electrolyte layer 42 can be determined by cutting the electrode substance-filled porous electrolyte layer 42 along the plane perpendicular to the surface of the electrolyte substrate 41 on which the electrode substance-filled porous electrolyte layer 42 is formed, and calculating the percentage of the cross-sectional area of the void 47 to the apparent cross-sectional area of the electrode substance-filled porous electrolyte layer 42 on an arbitrary cross-section. A specific method of measuring the porosity ratio of the electrode substance-filled porous electrolyte layer 42 will be explained with reference to FIG. 6. FIG. 6 is a drawing similar to FIG. 4, in which the area of void 47 in the electrode substance-filled porous electrolyte layer 42 in FIG. 4 is hatched. First, the electrode substance-filled porous electrolyte layer 42 is cut along an arbitrary plane perpendicular to the surface of the electrolyte substrate 41 on which the electrode substance-filled porous electrolyte layer 42 is formed. Then, the section of the electrode substance-filled porous electrolyte layer 42 in an SEM photograph obtained is surrounded by a frame to determine the area in a frame-encircled region 53 (the part surrounded by the solid line in FIG. 6). Next, the area of a cross-section 54 (the hatched part in the frame-encircled region 53 in FIG. 6) of the void 47 is determined. The porosity of the electrode substance-filled porous electrolyte layer 42 is calculated using the following formula (2).

Porosity of electrode substance-filled porous electrolyte layer 42(%)=(area of void cross-section 54)/(area in frame-encircled region 53)×100 (2)

The porosity of the electrode substance-filled porous electrolyte layer 42 is calculated at least at three places, and the average is regarded as the porosity of the electrode substance-filled porous electrolyte layer of the cell for solid oxide fuel cells of the present invention.

The substance with which the pores of the porous electrolyte layer 46 are filled is an electrode substance powder 45 in FIG. 4. The electrode substance powder used for forming the fuel electrode layer 43 on the surface of the electrode substance-filled porous electrolyte layer 42 differs according to the type of the electrode layer 43 to be formed. When forming a fuel electrode layer, a fuel electrode substance powder is used, and when forming an air electrode layer, an air electrode substance powder is used. In the cell for solid oxide fuel cells of the present invention, the same type of fuel electrode substance and air electrode substance used as the fuel electrode substance and air electrode substance in the above-mentioned production process can be used as the fuel electrode substance and the air electrode substance.

In addition, as the substance with which the porous electrolyte layer 46 is filled, the same mixed powder of the electrode substance powder and electrolyte substance powder (d) can be given. In this instance, the cell for solid oxide fuel cells of the present invention is the same cell as that shown in FIG. 4, except that a part of the substance powder 45 with which the pores of the porous electrolyte layer 46 in FIG. 4 are filled is replaced with the electrolyte substance powder (d). Specifically, when the electrode layer 43 is a fuel electrode layer, the substance with which the porous electrolyte layer 46 is filled is a mixture of a fuel electrode substance powder and the electrolyte substance powder (d), and when the electrode layer 43 is an air electrode layer, the substance with which the porous electrolyte layer 46 is filled is a mixture of an air electrode substance powder and the electrolyte substance powder (d). The same powdery materials as the electrolyte substance powder (b) in the above-mentioned production process can be used as the electrolyte substance powder (d) for the cell for solid oxide fuel cells of the present invention.

In addition, as the substance with which the porous electrolyte layer 46 is filled, a composite particle powder of an electrode substance and an electrolyte substance can be given. In this instance, the cell for solid oxide fuel cells of the present invention is the same cell as that shown in FIG. 4, except that a part of the substance powder 45 with which the pores of the porous electrolyte layer 46 in FIG. 4 are filled is replaced with the composite particle powder of an electrode substance and an electrolyte substance. The same composite particle powder in the above-mentioned production process can be used as the composite particle powder for the cell for solid oxide fuel cells of the present invention.

The average particle diameter of the electrode substance powder, the mixed powder, and the composite particle powder of the cell for solid oxide fuel cells of the present invention is preferably from 0.001 to 10 micrometers, particularly preferably from 0.005 micrometers to 1 micrometer, and still more preferably from 0.01 to 0.5 micrometers. The smaller the average particle diameter, the larger the amounts of the three-phase interface. If the average particle diameter is less than 0.001 micrometers, it is difficult to prepare a slurry containing the electrode substance powder, the mixed powder, or the composite particle powder, or performance of the fuel cell tends to become poor because of easy sintering during operation of the fuel cell. If the average particle diameter is more than 10 micrometers, the amount of the three-phase interface tends to decrease. In the case of the composite particle powder of the electrode substance and the electrolyte substance, the average diameter of the mother particles is deemed to be the average particle diameter of the composite particle powder of the electrode substance and the electrolyte substance.

Use of the mixed powder for filling the porous electrolyte layer 46 is preferable in order to ensure a high output of the fuel cell.

The volume ratio of the amount of the electrode substance powder, the mixed powder of the electrode substance powder and the electrolyte substance powder (d), or the composite particle powder of the electrode substance and the electrolyte substance filled in the pores of the porous electrolyte layer 46 to the apparent volume of the electrode substance-filled porous electrolyte layer 42 is from 5 to 50%, preferably from to 30%, and particularly preferably from 6 to 20%. Volume ratio in the above range ensures a high output of the fuel cell. The amount of the electrode substance powder, the mixed powder of the electrode substance powder and the electrolyte substance powder (d), or the composite particle powder of the electrode substance and the electrolyte substance filled in the pores of the porous electrolyte layer 46 can be determined by calculating the difference between (A) the volume ratio (%) of the pores of the porous electrolyte layer to the apparent volume of the electrode substance-filled porous electrolyte layer, which is determined by the above formula (1) and (B) the porosity (%) of the electrode substance-filled porous electrolyte layer determined by the above-mentioned formula (2), that is, by calculating [(volume ratio (%) of pores of porous electrolyte layer to apparent volume of electrode substance-filled porous electrolyte layer)−(porosity (%) of electrode substance-filled porous electrolyte layer)].

When the substance with which the pore of the porous electrolyte layer 46 are filled is the above mixed powder, the volume ratio of the electrolyte substance powder (d) to the electrode substance powder (electrolyte substance powder (d)/electrode substance powder) is from 0.1 to 2, preferably from 0.5 to 1.5, and particularly preferably from 0.6 to 1.0. A volume ratio in the above range ensures a high output of the fuel cell.

When the substance with which the pores of the porous electrolyte layer 46 are filled is the electrode substance powder or the mixed powder of the electrode substance powder and the electrolyte substance powder (d), the amount (volume) of the electrode substance filled in the porous electrolyte layer 46 to the apparent volume of the electrode substance-filled porous electrolyte layer 42 is from 5 to 50%, preferably from 5 to 30%, and particularly preferably from 6 to 20%. An amount (volume) in the above range ensures a high conductivity of the electrode substance-filled porous electrolyte layer.

In the cell for solid oxide fuel cells of the present invention, the electrode substance-filled porous electrolyte layer may be formed on either one surface or both surfaces of the electrolyte substrate. That is, the cell for solid oxide fuel cells of the present invention may have either one of a fuel electrode substance-filled porous electrolyte layer or an air electrode substance-filled porous electrolyte layer, or may have both the fuel electrode substance-filled porous electrolyte layer and the air electrode substance-filled porous electrolyte layer.

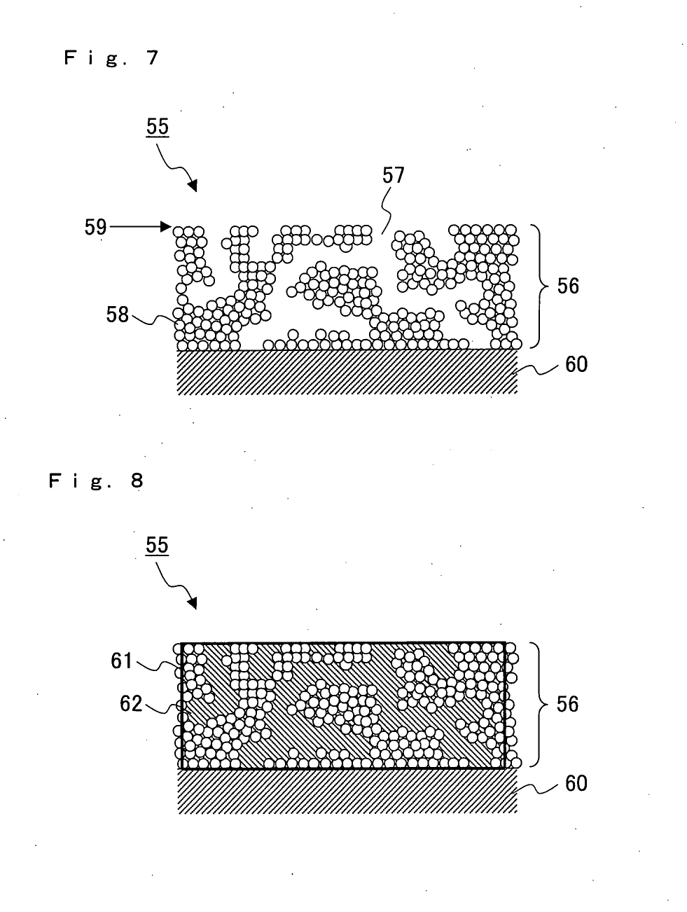

The electrode substance-filled porous electrolyte layer used in the cell for solid oxide fuel cells of the present invention can be obtained by filling pores of a porous electrolyte layer 56 shown in FIG. 7 with an electrode substance powder, a mixed powder of an electrode substance powder and the electrolyte substance powder (d), or a composite material powder of an electrode substance and an electrolyte substance. Illustrating the case for obtaining the electrode substance-filled porous electrolyte layer 42 shown in FIG. 4 as an example, as a method for filling the porous electrolyte layer 56 with the electrode substance powder 45, a method of applying a slurry for an electrode substance containing the electrode substance powder 45 to the surface of the porous electrolyte layer 56 formed on the electrolyte substrate 60, and baking the electrolyte substrate 60 on which the porous electrolyte layer 56 with the slurry for an electrode substance coated thereon is formed can be given. Specifically, pores 57 of the porous electrolyte layer 56 are impregnated with the slurry for filling an electrode substance by applying a slurry (a slurry for filling an electrode substance), in which an electrode substance powder 45 (a solid component) is dispersed in a liquid component, to a surface 59 of the porous electrolyte layer (the surface of the porous electrolyte layer opposite the surface in contact with the electrolyte substrate 60) of the electrolyte substrate 60 on which the porous electrolyte layer is formed, to fill the porous electrolyte layer 56 with the slurry for filling an electrode substance and, at the same time, a slurry layer for filling an electrode substance is formed on the surface 59 of the porous electrolyte layer opposite to the electrolyte substrate 60 of the porous electrolyte layer 56. Next, the electrolyte substrate 55, on which the porous electrolyte layer 56 is formed, coated with the slurry for filling an electrode substance is baked to burn down the liquid component in the slurry for filling an electrode substance and, at the same time, to cause the particles of the electrode substance powder 45, as well as particles of the electrode substance powder 45 and the electrolyte substance powder (c) 58, to be sintered in the areas in which these particles are in contact with each other. In this manner, the electrode substance-filled porous electrolyte layer 42 can be obtained.

The porous electrolyte layer 56 is the same as the porous electrolyte layer 46 constituting the electrode substance-filled porous electrolyte layer 42. That is, the porous electrolyte layer 56 is formed from an electrolyte substance, is porous, and has pores. The porosity of the porous electrolyte layer 56 is from 30 to 70%, preferably from 35 to 60%, and particularly preferably from 40 to 50%. The porosity of the porous electrolyte layer 56 refers to the volume ratio of the pores 57 to the apparent volume of the porous electrolyte layer 56.

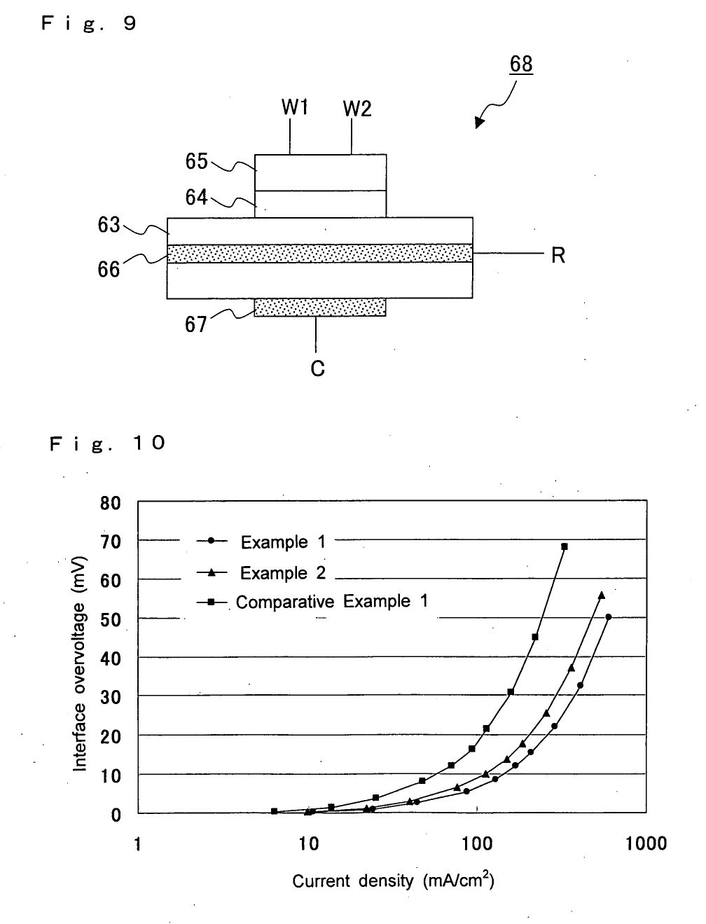

In the present invention, the porosity of the porous electrolyte layer 56 can be determined by cutting the porous electrolyte layer 56 along the plane perpendicular to the surface of the electrolyte substrate 60 on which the porous electrolyte layer 56 is formed, and calculating the percentage of the cross-sectional area of the pores to the apparent cross-sectional area of the porous electrolyte layer 56 on an arbitrary cross-section. A specific method of measuring the porosity of the porous electrolyte layer 56 will be explained with reference to FIG. 8. FIG. 8 is a drawing similar to FIG. 7, in which the pores 57 in the porous electrolyte layer 56 are hatched. First, the porous electrolyte layer 56 is cut along an arbitrary plane perpendicular to the surface of the electrolyte substrate 60 on which the porous electrolyte layer 56 is formed. The section is observed with a scanning electron microscope. Then, the section of the porous electrolyte layer 56 in an SEM photograph obtained is surrounded by a frame to determine the area in a frame-encircled region 61 (the part surrounded by the solid line in FIG. 8). Next, the area of a cross-section 62 (the hatched part in the frame-encircled region 61 in FIG. 8) of the pores 57 is determined. The porosity of the porous electrolyte layer 56 is calculated using the following formula (3).

Porosity of porous electrolyte layer 56(%)=(area of pore cross-section 62)/(area in frame-encircled region 61)×100 (3)

The porosity of the porous electrolyte layer 56 is calculated at least at three places, and the average is regarded as the porosity of the porous electrolyte layer of the cell for solid oxide fuel cells of the present invention.

A specific surface area of the porous electrolyte layer 56 is from 0.1 to 10 m²/g, preferably from 0.2 to 5 m²/g, and particularly preferably from 0.5 to 3 m²/g. The specific surface area in the above range ensures a high output of the fuel cell.

The conductivity of the porous electrolyte layer 56 at 1,000° C. is from 0.01 to 0.2 S/cm, preferably from 0.05 to 0.2 S/cm, and particularly preferably from 0.1 to 0.2 S/cm.

The amount of the pores with a pore width of 1 micrometer or less in the porous electrolyte layer 56 is preferably 10% or less, particularly preferably 5% or less, and still more preferably 3% or less. Since the pores with a pore width not more than 1 micrometer are difficult to be impregnated with the slurry for filling an electrode substance, the smaller the amount of the pores with a pore width of 1 micrometer or less, the larger the amount of the electrode substance powder, the mixed powder of the electrode substance powder and the electrolyte substance powder (d), and the composite particle powder of the electrode substance and the electrolyte substance filled in the pores. The amount of the pores with a pore width of 1 micrometer or less as used in the present invention refers to the percentage of the cross-sectional area of the pores with a pore width of 1 micrometer to the apparent cross-sectional area of the porous electrolyte layer 56 along an arbitrary plane perpendicular to the surface of the electrolyte substrate 60 on which the electrode substance-filled porous electrolyte layer 56 is formed. Such an amount is determined at least in three different cross-sections and averaged to determine the amount of the pores with a pore width of 1 micrometer or less.

In essence, the cell for solid oxide fuel cells of the present invention has an electrode substance-filled porous electrolyte layer, obtainable by filling pores of a porous electrolyte layer formed from a electrolyte substance with a porosity of 30 to 70%, and an electrode substance powder, a mixed powder of an electrode substance powder and an electrolyte substance powder, or a composite material powder of an electrode substance and an electrolyte substance.

The average particle diameter and average pore diameter were measured using “MICROTRAC-S3000” (manufactured by Nikkiso Co., Ltd.).

The present invention will be described in more detail by examples, which should not be construed as limiting the present invention.

### EXAMPLES

### Example 1

### Preparation of Fuel Electrode Layer

### (Preparation of Slurry for Forming Fuel Electrode Layer)

55 g of nickel oxide (NiO), 45 g of scandia ceria-stabilized zirconia (10Sc1CeSZ), 10 ml of di-n-butyl phthalate, 2 ml of octyl phenyl ether, 2 ml of a dispersant (“Nonion OP-83RAT” manufactured by NOF Corp.), 10 g of polyvinyl butyral resin (manufactured by Wako Pure Chemical Industries, Ltd.), 80 ml of isopropanol, and 80 ml of acetone were added to a ball mill, and mixed at room temperature for 24 hours. The solvent was evaporated from the resulting slurry using an evaporator under reduced pressure to make the viscosity of the slurry 10,000 mPa·s, thereby obtaining a slurry A for forming a fuel electrode.

Nickel oxide (average particle diameter: 7 micrometers)

Scandia ceria-stabilized zirconia (scandia content in zirconia: 10 mol %, ceria content in zirconia: 1 mol %, average particle diameter: 0.55 micrometers)

### (Baking of Slurry for Forming a Fuel Electrode Layer)

A slurry layer for forming a fuel electrode with a film thickness of 700 micrometers was formed from the slurry A for forming a fuel electrode, dried, and baked at 1,400° C. for three hours to obtain a fuel electrode B.

### (Preparation of Electrolyte Substrate)

### (Preparation of Slurry for Forming Electrolyte Substrate)

55.02 g of scandia ceria-stabilized zirconia (10Sc1CeSZ) used for preparing the slurry for forming a fuel electrode layer, 10 ml of di-n-butyl phthalate, 2 ml of octyl phenyl ether, 2 ml of the dispersant used for preparing the slurry for forming a fuel electrode layer, 5 g of polyvinyl butyral resin used for preparing the slurry for forming a fuel electrode layer, 80 ml of isopropanol, and 80 ml of acetone were added to a ball mill, and mixed at room temperature for 24 hours. The solvent was evaporated from the resulting slurry using an evaporator under reduced pressure to make the viscosity of the slurry 10,000 mPa·s, thereby obtaining a slurry C for forming electrolyte substrate.

### (Baking of Slurry for Forming an Electrolyte Substrate)

The slurry C for forming an electrolyte substrate was applied to one of the surfaces of the fuel electrode B by a screen printing method to obtain a coating with a thickness of 10 micrometers. The coating was dried and baked at 1,400° C. for five hours to obtain an electrolyte substrate D (hereinafter referred to simply as “electrolyte substrate D”) with a dense layer of the electrolyte substance formed on the surface of fuel electrode layer B.

### (Formation of Porous Electrolyte Layer)

### (Preparation of slurry for forming porous electrolyte layer)

70.8 g of scandia ceria-stabilized zirconia (10Sc1CeSZ) used for preparing the slurry for forming a fuel electrode layer, 29.2 g of carbon powder, 10 ml of di-n-butyl phthalate, 2 ml of octyl phenyl ether, 2 ml of the dispersant used for preparing the slurry for forming a fuel electrode layer, and 5 g of polyvinyl butyral resin used for preparing the slurry for forming a fuel electrode layer, 80 ml of isopropanol, and 80 ml of acetone were added to a ball mill, and mixed at room temperature for 24 hours. The solvent was evaporated from the resulting slurry using an evaporator under reduced pressure to make the viscosity of the slurry 10,000 mPa·s, thereby obtaining a slurry E for forming a porous electrolyte layer.

Carbon powder (average particle diameter: 5 micrometers, manufactured by Japan Pure Chemical Co., Ltd.)

### (Application and Baking of Slurry for Forming Porous Electrolyte Layer)

The slurry E for forming a porous electrolyte layer was applied to the surface of the electrolyte substrate D opposite the surface on which the fuel electrode layer was formed to obtain a coating with a thickness of 10 micrometers by a screen printing method. The coating was then dried. Then, the electrolyte substrate D on which the slurry E for forming a porous electrolyte layer was applied was baked at 1,400° C. for three hours to obtain an electrolyte substrate F (hereinafter referred to simply as “electrolyte substrate F”) with a porous electrolyte layer formed thereon.

### (Analysis of Porous Electrolyte Layer)

### 1. Measurement of Porosity of Porous Electrolyte Layer

The electrolyte substrate F was cut along the plane perpendicular to the surface of the electrolyte substrate to inspect the cross-section using a scanning electron microscope. The porosity of the porous electrolyte layer of the electrolyte substrate F was determined according to the above-described method using the SEM photograph obtained. The porosity was measured at three different measuring points and the results were averaged to find that the average porosity was 44%.

### 2. Measurement of Specific Surface Area

The specific surface area of the porous electrolyte layer of the electrolyte substrate F was measured by a Kr gas adsorption method using a full automatic gas adsorption analyzer “AUTOSORB-1-C/VP/TCD/MS.” As a result, the specific surface area was found to be 0.67 m²/g.

### 3. Measurement of conductivity

An alumina square pillar, with a width of 5 mm, a length of 30 mm, and a height of 0.5 mm was coated with the slurry E for forming a porous electrolyte layer, followed by baking, to obtain a porous electrolyte layer with a width of 5 mm, a length of 30 mm, and a height of 0.05 mm. The conductivity at 1,000° C. of the porous electrolyte layer of the electrolyte substrate F was measured by a direct current four terminal method and an alternate current four terminal method. As a result, the conductivity was 0.07 S/cm.

### 4. Amount of the Pores with Pore Width of 1 Micrometer or Less

The amount of the pores with a pore width of 1 micrometer or less in the porous electrolyte layer of the electrolyte substrate F was determined according to the above-described method using the SEM photograph which was used in the measurement of porosity. The amount of the pores with a pore width of 1 micrometer or less was measured at three different measuring points and the results were averaged to find that the amount was 5%.

### (Formation of Air Electrode Layer)

### (Preparation of Slurry for Forming Air Electrode Layer)

82 g of lanthanum strontium manganate (Ln_{0.8}Sr_{0.2}Mn_{1.0}O₃), 18 g of scandia ceria-stabilized zirconia (10Sc1CeSZ) used for preparing the slurry for forming a fuel electrode layer, 10 ml of di-n-butyl phthalate, 2 ml of octyl phenyl ether, 2 ml of the dispersant used for preparing the slurry for forming a fuel electrode layer, 10 g of polyvinyl butyral resin used for preparing the slurry for forming a fuel electrode layer, 80 ml of isopropanol, and 80 ml of acetone were added to a ball mill, and mixed at room temperature for 24 hours. The solvent was evaporated from the resulting slurry using an evaporator under reduced pressure to make the viscosity of the slurry 10,000 mPa·s, thereby obtaining a slurry G for forming an air electrode layer.

Lanthanum Strontium Manganate (Average Particle Diameter: 0.49 Micrometers)

### (Baking of Slurry for Forming Air Electrode)

The electrolyte substrate F was obtained in the same manner as above. The slurry G for forming an air electrode layer was applied to the surface of the porous electrolyte layer of the electrolyte substrate F by a screen printing method to obtain a coating with a thickness of 20 micrometers. The coating was then dried. Then, the electrolyte substrate F on which the slurry G for forming an air electrode layer was applied was baked at 1,200° C. for three hours to obtain a cell H for solid oxide fuel cells.

The volume ratios of the scandia ceria-stabilized zirconia and lanthanum strontium manganate to the apparent volumes of the air electrode substance-filled porous electrolyte layer in the air electrode substance-filled porous electrolyte layer of the cell H for solid oxide fuel cells were respectively 60.8% and 7.2%.

### Performance Evaluation

In order to detect the differences in the power generation characteristics according to the differences in the electrode substance-filled porous electrolyte layer, a constant polarization was measured. FIG. 9 is a side elevation of a constant polarization measuring sample for measuring the constant polarization. A constant polarization measuring sample 68 has a cylindrical electrolyte pellet 63 with a diameter of 15 mm and a thickness of 2 mm, a cylindrical air electrode substance-filled porous electrolyte layer 64 with a diameter of 6 mm and a thickness of 10 micrometers formed on one of the surfaces of the electrolyte pellet 63, disposed concentrically in the center thereof, a cylindrical air electrode layer 65 with a diameter of 6 mm and a thickness of 20 micrometers formed on the surface of the air electrode substance-filled porous electrolyte layer 64, a platinum reference electrode 66 with a width of 1.0 mm, formed around the side of the cylindrical electrolyte pellet 63 over the entire circumference thereof, and a platinum counter electrode 67 with a diameter of 6 mm formed on the one of the surfaces of the electrolyte pellet 63, disposed concentrically in the center thereof.

Illustrating the method of preparing the constant polarization measurement sample 68, after pressing the scandia ceria-stabilized zirconia (10Sc1CeSZ) used for preparing the slurry for forming the fuel electrode at a load of 0.3183 t/cm², the pressed scandia ceria-stabilized zirconia was baked at 1,400° C. for three hours to obtain a cylindrical electrolyte pellet 63 with a diameter of 15 mm and a thickness of 2 mm.

The slurry E for forming a porous electrolyte layer was applied to the center of one of the surfaces of the electrolyte pellet 63 to obtain a coating with a diameter of 6 mm and a thickness of 10 micrometers by a screen printing method, followed by drying. Then, the electrolyte pellet 63 coated with the slurry for forming the electrolyte substrate E was baked at 1,400° C. for three hours to obtain the electrolyte pellet 63 on which a porous electrolyte layer was formed.

Next, the slurry G for forming an air electrode layer was applied to the surface of the electrolyte pellet 63 on which the porous electrolyte layer was formed by a screen printing method to obtain a coating with a thickness of 20 micrometers, followed by drying. Then, the electrolyte pellet 63 coated with the slurry G for forming an air electrode was baked at 1,200° C. for three hours to obtain the electrolyte pellet 63 on which the air electrode substance-filled porous electrolyte layer 64 and the air electrode layer 65 were formed.

A platinum paste (“TR-7905” manufactured by Tanaka Kikinzoku Kogyo Co., Ltd.) was applied to the sides and the other surface of the electrolyte pellet 63 on which the air electrode substance-filled porous electrolyte layer 64 and the air electrode layer 65 were formed, followed by baking at 1,000° C., to obtain a constant polarization measuring sample 68.

The current density between W2-C of the constant polarization measuring sample 68 was measured in an atmosphere at 1,000° C. while changing the electric potential between W1-R (interface overvoltage) using an impedance measurement apparatus (manufactured by made by Solrtron Co.). The results are shown in Tables 1 and 10.

### Example 2

Preparation of a fuel electrode, preparation of an electrolyte substrate, formation of a porous electrolyte layer, and formation of an air electrode layer were carried out in the same manner as in Example 1, except for using 100 g of lanthanum strontium manganate instead of 82 g of lanthanum strontium manganate and 18 g of scandia ceria-stabilized zirconia used in the preparation of the slurry for fuel electrode layer to obtain a cell for solid oxide fuel cells J. The volume ratios of the scandia ceria-stabilized zirconia and lanthanum strontium manganate to the apparent volume of the air electrode substance-filled porous electrolyte layer in the air electrode substance-filled porous electrolyte layer of the cell for solid oxide fuel cells J were respectively 56% and 12%.

### Performance Evaluation

The same experiment as in Example 1 was carried out except for using the slurry for forming an air electrode used in Example 2 instead of the slurry for forming an air electrode G. The results are shown in Tables 1 and 10.

### Comparative Example 1

The same experiment as in Example 1 was carried out except that the formation of a porous electrolyte layer was omitted, that is, preparation of a fuel electrode, preparation of an electrolyte substrate, and formation of an air electrode layer were carried out in the same manner as in Example 1 to obtain a cell for solid oxide fuel cells K.

### Performance Evaluation

The same experiment as in Example 1 was carried out except that the formation of a porous electrolyte layer was omitted. The results are shown in Tables 1 and 10. That is, the constant polarization measuring sample obtained in Comparative Example 1 was essentially obtained by preparing an electrolyte pellet and forming an air electrode layer, a first reference electrode, and a second reference electrode in the same manner as in Example 1.

TABLE 1

| Example 1 | | Example 2 | | Comparative Example 1 | |
|---|---|---|---|---|---|
| Current density | Interface overvoltage | Current density | Interface overvoltage | Current density | Interface overvoltage |
| (mA/cm²) | (mV) | (mA/cm²) | (mV) | (mA/cm²) | (mV) |
| 10.6 | 0.2 | 9.9 | 0.3 | 6.4 | 0.4 |
| 24.1 | 1.0 | 21.9 | 1.1 | 13.8 | 1.5 |
| 44.2 | 2.6 | 40.0 | 2.9 | 25.1 | 3.7 |
| 86.7 | 5.5 | 75.7 | 6.6 | 47.7 | 8.0 |
| 127.3 | 8.7 | 112.8 | 10.1 | 71.1 | 12.1 |
| 167.6 | 11.9 | 147.5 | 13.9 | 93.7 | 16.4 |
| 205.8 | 15.5 | 181.8 | 17.9 | 113.2 | 21.5 |
| 286.5 | 22.0 | 251.1 | 25.6 | 156.3 | 30.6 |
| 403.2 | 32.5 | 357.2 | 36.9 | 219.3 | 44.8 |
| 597.7 | 50.0 | 534.1 | 55.6 | 325.4 | 68.0 |

### INDUSTRIAL APPLICABILITY

A solid oxide fuel cell excelling in cell performance can be produced by using the cell for solid oxide fuel cells or the process for producing the cell for solid oxide fuel cells of the present invention.

1: A process for producing a cell for solid oxide fuel cells comprising a porous electrolyte layer-forming step of obtaining an electrolyte substrate in which a porous electrolyte layer is formed by applying a slurry for forming an electrolyte layer containing an electrolyte substance powder and a pore-forming agent to the surface of an electrolyte substrate and burning the electrolyte substrate, and an electrode layer-forming step of obtaining an electrolyte substrate in which an electrode substance-filled porous electrolyte layer and an electrode layer are formed by applying a slurry for forming an electrode containing an electrode substance powder, a mixture of an electrode substance powder and an electrolyte substance powder, or a composite material powder of an electrode substance and an electrolyte substance, onto the surface of the porous electrolyte layer of the electrolyte substrate on which the porous electrolyte layer is formed, and burning the electrolyte substrate in which the porous electrolyte layer is formed.

2: The process according to claim 1, wherein the ratio of the average particle diameter of the electrode substance powder, the mixed powder, or the composite particle powder of the electrode substance and the electrolyte substance contained in the slurry for forming the electrode layer to the average pore diameter of the pore-forming agent is from 0.001 to 1.

3: The process according to claim 1, wherein the ratio of the average pore diameter of the pore-forming agent to the average particle diameter of the electrode substance powder contained in the slurry for forming the electrode layer is from 2 to 1,000.

4: The process according to claim 1, wherein the ratio of the volume of the electrolyte substance powder contained in the slurry for forming the electrolyte layer to the volume of the pore-forming agent in the slurry for forming the electrolyte layer is from 0.1 to 10.

5: A cell for solid oxide fuel cells having an electrode substance-filled porous electrolyte layer, obtainable by filling pores of a porous electrolyte layer having a porosity of 30 to 70% with an electrode substance powder, a mixed powder of an electrode substance powder and an electrolyte substance powder, or a composite material powder of an electrode substance and an electrolyte substance.

6: The cell according to claim 5, wherein the specific surface area of the porous electrolyte layer is from 0.1 to 10 m²/g.

7: A cell for solid oxide fuel cells having an electrode substance-filled porous electrolyte layer comprising a porous electrolyte layer formed from an electrolyte substance and an electrode substance powder, a mixed powder of an electrode substance powder and an electrolyte substance powder, or a composite material powder of an electrode substance and an electrolyte substance, filled in the pores of the porous electrolyte layer, the pore volume ratio of the porous electrolyte layer to the apparent volume of the electrode substance-filled porous electrolyte layer being 30 to 70%.

8: The cell according to claim 5, wherein the volume of the electrode substance powder filled in the porous electrolyte layer is from 5 to 50% of the apparent volume of the electrode substance-filled porous electrolyte layer.
